(19) United States
(12) Patent Application Publication
(10) Pub. No.: US 2004/0227021 A1
(43) Pub. Date: Nov. 18, 2004

(54) Tool-free, quick disconnect, nozzle assembly

(75) Inventors: Alan S. Romack, Columbia, MD (US); Ronald Tobb, Brookeville, MD (US)

Correspondence Address: LARRY J. GUFFEY, WORLD TRADE CENER - SUITE 1800, 401 EAST PRATT STREET, BALTIMORE, MD, 21202, US

(73) Assignee: Bowles Fluidics Corporation

(21) Appl. No.: 10/847,266

(22) Filed: May 17, 2004

Related U.S. Application Data
(60) Provisional application No. 60/471,457, filed on May 16, 2003.

(51) Int. Cl. B05B 3/00

(52) U.S. Cl. 239/589.1; 239/589; 239/590

(57) ABSTRACT

A nozzle assembly for connecting to the outlet of a fluid flow source and providing a specified fluid flow spray includes: (a) a connector having a flow passage which extends between its ends, with the connector's upstream end being configured so as to mate with the fluid flow source's outlet, and with this connector passage at a point between its ends having a connector orifice, (b) a nozzle in the form of a fluidic insert configured so as to generate a specified fluid flow spray, (c) a housing having a fluid flow passage which extends between its ends and a rib which extends outwardly from the housing's exterior surface, with the portion of the housing's passage proximate its downstream end being configured so as to allow for the insertion and housing of the fluidic insert, and with the housing's upstream end being configured so as to be rotatably mounted in the connector fluid flow passage's downstream end, and (d) a retention cap having an opening extending between its ends that is configured to allow the housing downstream end to project through the opening, with the cap's upstream end being configured to mate with the housing's rib and the connector downstream end so as to hold the housing and connector in a proximal relationship which aids in preventing fluid flow leakage at their junction.

### CROSS-REFERENCE TO RELATED APPLICATION

This application claims the benefit of U.S. Provisional Patent Application No. 60/471,457, filed May 16, 2003 by Alan S. Romack and Ronald Tobb.

### BACKGROUND OF THE INVENTION

1. Field of the Invention

This invention relates to fluid spraying apparatus. More particularly, this invention relates to a fluid flow nozzle assembly that can be quickly and easily changed without the use of tools.

2. Description of the Related Art

Quick disconnect spray nozzle assemblies, of the type shown in U.S. Pat. Nos. 6,398,128, 5,727,739, 5,190,224 and 5,421,522, have generally enjoyed considerable success in a wide range of industrial applications.

These assemblies generally consist of a spray tip and a nozzle body. The nozzle body usually is configured so that it has, at one of its ends, external threads which are used to connect the nozzle body to a pipe through which fluid is supplied to the nozzle. See FIG. 1 from U.S. Pat. No. 6,398,128.

These assemblies also typically have cooperating lugs and stops that allow the spray tip and nozzle body to be locked together by a predetermined amount of rotational movement of the spray tip relative to the nozzle body. This arrangement allows such spray tips to be easily removed from and replaced in the nozzle body.

Despite their wide use, such nozzle assemblies present significant operational problems in certain situations. For example, these assemblies generally do not have a means whereby the flow through such nozzles can be turned off; thus necessitating the insertion of a turn-off valve in close proximity to every such nozzle assembly. Additionally, when such nozzle assemblies are fed by contaminated or dirty fluid sources, it can often happen that these nozzles will become plugged by dirt particles being caught within the nozzle's flow passages. Furthermore, these assemblies' use of threaded couplings usually necessitate that a wrench be used to completely disassemble and clean such nozzles of any debris that might be plugging their flow passages.

The parts for these assemblies are frequently made by plastic injection molding, with some elements (e.g., the lugs and stops on the spray tip) of these parts requiring complex tooling for the plastic injection molding process. Such plastic injection molding tooling details can significantly limit design alternatives in such molded plastic spray nozzle assemblies.

Tooling costs also can be prohibitively expensive for a small production lot of such spray nozzle assemblies. For example, there are dozens of types of spray tips that can be required for particular spray applications. To design, tool, and manufacture individual spray nozzle assemblies, on a small lot-basis, for each spray application simply is often not economical.

To overcome such problems, attempts have been made to design nozzle assemblies that contain a reusable housing which holds a replaceable spray nozzle in place. See FIG. 2(a) which displays a commercial, cone nozzle assembly available from Lechler, Inc., St. Charles, Ill.

Rather than just a spray tip and nozzle body, this assembly consists of a replaceable cone nozzle, a tube-like sealing member, a front housing member and a rear housing member, with the upstream end of this rear housing member serving essentially the same purpose as the upstream end of the nozzle body seen in U.S. Pat. No. 6,398,128 (i.e., containing a connector surface for attachment of the nozzle to a pipe carrying a source of fluid to feed the nozzle). Again, this nozzle assembly contains no direct means by which the fluid flow through the nozzle may be turned off and these nozzle assemblies are not easy to totally disassemble and clean.

Also shown in FIG. 2(b) is a standard means for connecting such a nozzle to a pipe which supplies fluid to the nozzle. Since the upstream end of the assembly's rear housing consists of a threaded, male pipe fitting, a standard piping adapter is used to connect the rear housing member to a piping T-element which has a female end that can accommodate the enlarged male end of the piping adapter. While such standard piping connections can be easy to assemble, they can have disadvantages in certain situations. For example, in those instances where it is desired that the tip end of the nozzle assembly not extend too great a distance from the centerline of the pipe which supplies fluid to such nozzles, the use of such connectors is problematic since they can often result in nozzle tips that extend relatively far from their fluid supply pipe.

The disadvantages of such nozzle assemblies have been made clearer by the recent increase demand for the use of such nozzles in assorted decontamination spray facilities. In such facilities, these nozzle assemblies will often be used in areas where the maintenance personnel who must service such nozzles are required to be clothed totally in protective gear. In such gear, it is inconvenient for the maintenance personnel to have to carry the wrenches or other tools necessary to quickly open and clean such nozzles when they become plugged by whatever dirty water that passes through them. Also, because such decontamination facilities can be designed to have large numbers of people passing through them for the purposes of being decontaminated, the problem, of these assemblies having nozzle tips that extend a considerable distance from the centerline of the pipe in which such nozzle assemblies are mounted, can be significant in that such extended tips create a snagging hazard to those moving through the facility.

Thus, despite the prior art, there still exists a continuing need for improvements in the design of easy-to-maintain, quick disconnect, nozzle assemblies.

3. Objects and Advantages

Recognizing the need for the development of improved nozzle assemblies, the present invention is generally directed to satisfying the needs set forth above and overcoming the disadvantages identified with prior art devices.

It is an object of the present invention to provide an easy-to-maintain, quick disconnect, spray nozzle assembly.

Another object is to provide a quick disconnect, spray nozzle assembly that can be opened and cleaned by hand and without the use of wrenches, etc.

A further object is to provide an easy-to-maintain, quick disconnect, spray nozzle assembly having the ability that the flow through the assembly can be turned-off without having to introduce a separate turn-of valve in the piping line for the nozzle assembly.

Yet another object is to provide a quick disconnect, spray nozzle assembly that can easily be operated by one wearing full protective gear and having only a gloved hand to operate or maintain the nozzle assembly.

A further object is to provide a quick disconnect, spray nozzle assembly which is compact and relatively simple in design and which lends itself to economical manufacture.

A still further object of the present invention to provide an easy-to-maintain, quick disconnect, spray nozzle assembly which can accommodate a variety of nozzles that interchangeable within the assembly.

These and other objects and advantages of the present invention will become readily apparent as the invention is better understood by reference to the accompanying drawings and the detailed description that follows.

### SUMMARY OF THE INVENTION

Recognizing the needs for the development of improved nozzle assemblies, the present invention is generally directed to satisfying the needs set forth above and overcoming the disadvantages identified with prior art devices and methods.

In a first preferred embodiment, a nozzle assembly for connecting to the outlet of a fluid flow source and providing a specified fluid flow spray includes: (a) a connector having a flow passage which extends between its ends, with the connector's upstream end being configured so as to mate with the fluid flow source's outlet, and with this connector passage at a point between its ends having a connector orifice and a surrounding surface, (b) a nozzle in the form of a fluidic insert which is configured so as to generate a specified fluid flow spray, (c) a housing having a fluid flow passage which extends between its ends and a rib which extends outwardly from the housing's exterior surface, with the portion of the housing's passage proximate its downstream end being configured so as to allow for the insertion and housing of the fluidic insert, and with the housing's upstream end being configured so as to be rotatably mounted in the connector flow passage's downstream end, with the housing being rotatable being a first position in which no fluid flows through the passages and a second position in which fluid flows through the passages, and (d) a retention cap having an opening extending between its ends that is configured to allow the housing downstream end to project through this opening, with the cap's upstream end being configured to mate with the housing's rib and the connector downstream end so as to hold the housing and connector in a proximal relationship which aids in preventing fluid flow leakage at their junction.

In other preferred embodiments, the fluidic inserts of the present invention have any one of a number fluid circuits molded therein. These circuits can generate fluid sprays with droplets having specified average sizes at various prescribed flow rates, including: 0.8-1.5 mm at 0.3-0.5 gpm, 1.0-2.0 mm at 0.75-1.25 gpm and 0.05-0.20 mm at 0.01-0.03 gpm.

Thus, there has been summarized above, rather broadly, the present invention in order that the detailed description that follows may be better understood and appreciated. There are, of course, additional features of the invention that will be described hereinafter and which will form the subject matter of any eventual claims to this invention.

### BRIEF DESCRIPTION OF THE DRAWINGS

FIG. 1 is a perspective view of the prior art, quick disconnect, nozzle assembly shown in U.S. Pat. Nos. 6,398,128.

FIG. 2A is a perspective view of a prior art, quick disconnect, nozzle assembly that is commercially available from Lechler, Inc., St. Charles, Ill. valve having a “carrier assembly.”

FIG. 2B is a perspective view which illustrates how the nozzle assembly shown in FIG. 2A might be piped into a source of fluid to supply fluid to the assembly.

FIG. 3 shows an exploded view of a preferred embodiment of the present invention.

FIG. 4 shows the same nozzle assembly shown in FIG. 3, but with dashed lines showing the internal configurations of these pieces of the assembly.

FIG. 5 shows another preferred embodiment of the present invention in which an alternative, fluidic type of nozzle is being used.

FIG. 6 shows the same nozzle assembly shown in FIG. 5, but with dashed lines showing the internal configurations of the various pieces of the assembly.

FIGS. 7A-7B show a perspective and a cross-sectional view of the piping tee element of the embodiment initially shown in FIG. 5.

FIGS. 8A-8C show a perspective bottom, cross-sectional and top view of the housing member element of the embodiment initially shown in FIG. 5.

FIGS. 9A-9B show a perspective and a cross-sectional view of the retention cap element of the embodiment initially shown in FIG. 5.

FIG. 10 shows another preferred embodiment of the present invention in which fluidic inserts are used and the top of its tee or connector element is configured to allow for a threaded connection to a fluid supply source.

FIGS. 11A-11B show perspective, exploded views of a preferred embodiment of a fluidic insert for use in the present invention to yield water sprays having droplets with an average size of 0.8-1.5 mm at flowrates of about 0.3-0.5 GPM.

FIGS. 12A-12B show perspective, exploded views of a preferred embodiment of a fluidic insert for use in the present invention to yield water sprays having droplets with an average size of 1.0-2.0 mm at flowrates of about 0.75-1.25 GPM.

FIGS. 13A-13B show perspective views of a preferred embodiment of a fluidic insert for use in the present invention to yield water sprays having droplets with an average size of 0.05-0.20 mm at flowrates of about 0.01-0.03 GPM.

FIG. 14 shows more details of the fluidic circuit shown in FIGS. 13A-13B.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

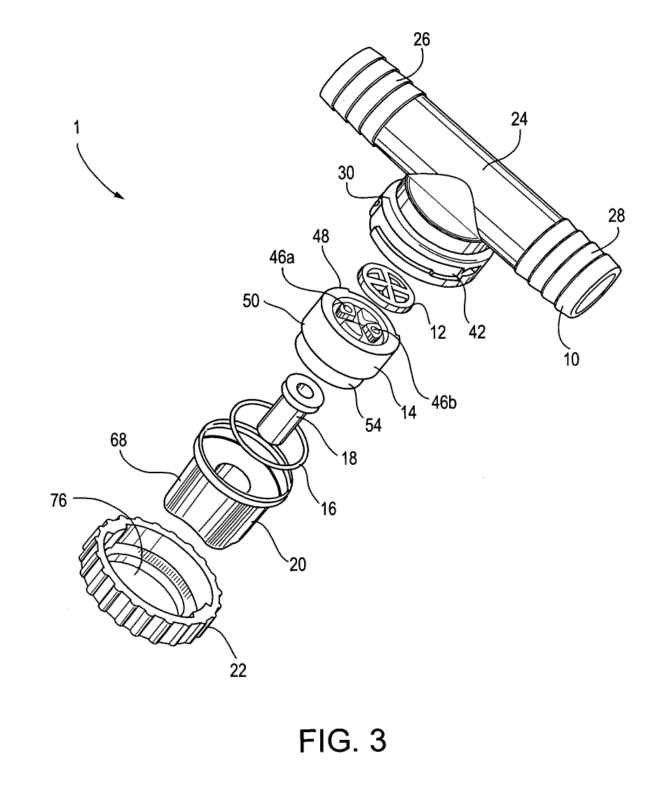

FIG. 3 shows an exploded view of a preferred embodiment of the present invention. It is an easy-to-maintain, quick disconnect, nozzle assembly 1 that can accommodate one of a variety of specially designed, replaceable nozzles in an assembly that can be easily opened by hand and without the use of wrenches, etc. This assembly consists of an especially designed, piping tee or connector element 10, a first sealing gasket 12, a rear, upstream housing member 14, a second gasket 16, a replaceable nozzle 18, a front housing member 20 and a retention cap 22.

Interchangeability of nozzles within this assembly can be achieved by opening the front and rear parts of the housing so as to insert a preferred nozzle. Alternatively, this interchangeability feature can be achieved by prefabricating a number of housings in which the front and rear housing members are sealed together with various preferred nozzles inside the housing. The housings themselves are then interchanged within the assembly.

The piping tee 10 element of this embodiment is seen to consist of a standard pipe 24 which forms the top portion of the tee and has ends 26, 28 which are configured for mating with the piping which brings the fluid supply to the nozzle assembly. The base 30 of the tee is of considerably larger diameter than the tee's top portion. This proves to be useful in sizing the front housing member 20, which also serves as a valve handle, so that it can be easily turned by one wearing gloves.

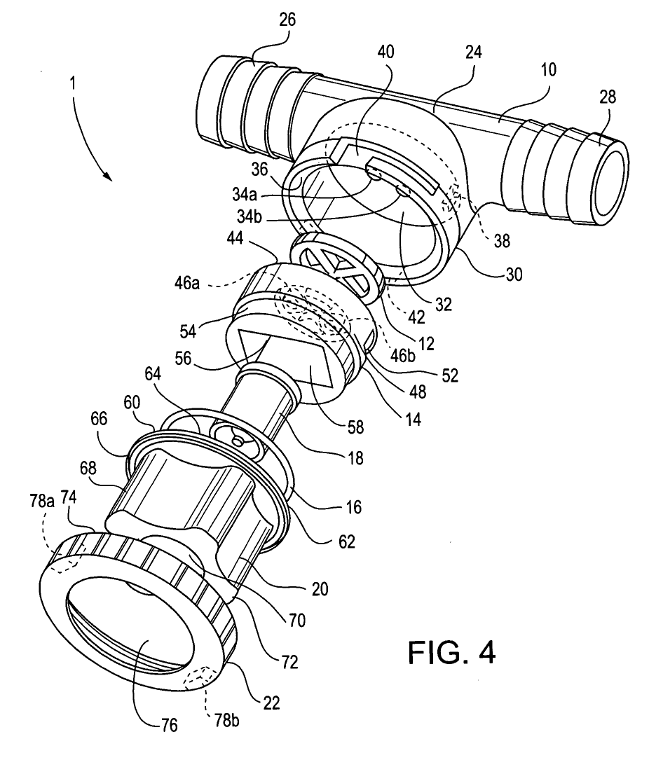

The bottom 32 of tee's base is flat to allow a tight seal to be made with the bottom surface of the rear housing member 14 which sits flush on the base's bottom surface 32. See FIG. 4. This base bottom surface 32 has two connector orifices or holes 34a, 34b which allow the fluid which passes through the tee's top portion to begin its journey through the nozzle assembly. The surface immediately surrounding these orifices is configured to aid in connecting the upstream end of this housing member 14 to the connector so as to minimize fluid leakage about these orifices 34a, 34b. The inner wall 36 of the base has a protuberance 38 which is configured to mate with a slot on the rear housing member's outer surface so as to act as a stop to restrict the amount of angular rotation, related to the valving function of this member, that this member can experience when properly seated in the tee's base portion.

The top, outer portion of the tee's base wall has matching vertical and horizontally configured slots 40, 42 which mate with protuberances on either side of the inside surface of the retention cap 22 so as to form a means for locking the retention cap into the piping tee by the rotation of the retention cap 22 relative to the tee 10 when the protuberances are properly located in their respective slots 40, 42.

The bottom surface 44 of the rear housing member 14 is generally flat so that it can mate well with the bottom 32 of the tee's base. Two housing orifices or holes 46a, 46b in this surface allow the fluid to continue to pass thru this member. To prevent leakage from these holes or the holes 34a, 34b in the tee, a sealing gasket 12 is used. This bottom surface also has a grove 48 which is configured in such a way so as to form a seat which serves to hold the gasket 12 in place.

The bottom outer surface 50 of the rear housing member also has a slot 52 which serves, in conjunction with the tee's inner protuberance 38, to restrict the amount of angular rotation associated with valving that this member may experience when seated in the tee's base. When the holes 34a, 34b and 46a, 46b are aligned, or have overlapping surfaces areas, fluid may flow freely through the nozzle. However, when this member 14 is rotated by approximately ninety degree, these holes are seen to be totally misaligned so that no flow can occur through the nozzle. Varying the degree of alignment between these orifices is seen to vary the fluid flow rate through the nozzle assembly.

The rear housing member's top outer surface is also seen to have a change in diameter so as to yield a ledge 54 on which the second gasket 16 may sit. To enable alignment of the front and rear housing members, the top surface of the rear housing member has one or more protuberances 56 which are configured so as to mate with corresponding depressions in the bottom surface of the front housing member 20.

Depending upon the type and shape of the disposable nozzle to be with this assembly, the interior portions of both the rear and front housing members will usually be configured so as to form a cavity 58 which can accept and hold the selected nozzle in place. The bottom surface 60 of the front housing member contains the opening to a central cavity 62 which is configured to accept the top portion of the selected nozzle to be used with this assembly. It also has a depression 64 which mate with the protuberances on the rear housing member's top surface so as to lock these housing parts together. The bottom 66 outer surface of this member is also configured so as to mate with the top portion of the rear housing member's outer surface and to form a water tight seal in conjunction with the second gasket 16.

The top portion 68 of this outer surface has been configured so that it can serve as a handle which can easily be gripped and angularly rotated so as to open or close the flow through the nozzle. An opening 70 in the top surface 72 of this member connects with it's interior cavity 62 so as to form a passage which allows the 18 fluid from the nozzle's orifice to be sprayed into the surrounding environment.

The bottom surface 74 of the retention cap 22 has a central opening 76 and protuberances 78a, 78b which can be mated with the tee's outer slots 40, 42 so as to lock these two pieces together.

As previously mentioned and now seen by the operation of this embodiment, one of the advantages of the present invention over that of the prior art is that this entire nozzle assembly can be totally disassembled for cleaning or replacement of the enclosed nozzle tip by merely rotating by hand the retention cap a few angular degree relative to its piping tee. A piping wrench is not needed for this task. Thus, even one wearing total protective gear and with gloved hand can easily maintain the present nozzle assembly.

Furthermore, by merely angularly rotating the top of the housing member, that extends through the retention cap, relative to the piping tee, the rate of fluid flow through this nozzle assembly can be controlled.

Additionally, by the use of alternative nozzles, within the housing members' especially configured cavities, a great amount of control can be maintained over the operational characteristics of the fluid sprays emanating from such nozzle assemblies.

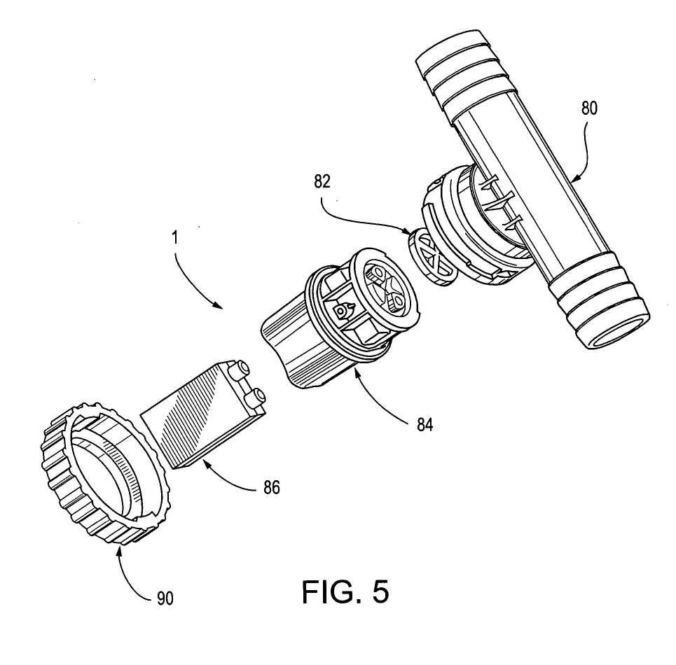

FIG. 5 shows a second preferred embodiment of the present invention which is especially designed to accommodate an alternative type of replaceable nozzle 18. In this instance, the nozzle is an especially designed fluidic device which can provide relatively uniform liquid droplet sizes over a wide range of operating pressures.

This embodiment or assembly 1 consists of a connector or piping tee 80 which is similar to that previously described. It also has a sealing gasket 82, a housing member 84, a fluidic insert 86, in which is molded a fluidic circuit 88, and a retention cap 90.

The fluidic insert 86 which is used in the present invention is a substantially rigid body member which has flat, parallel top and bottom outer surfaces. This member is preferably molded or fabricated from plastic, which is slightly deformable when subjected to compression forces exerted substantially normal to its outer surfaces. A fluidic circuit 88 which is chosen to provide a desired spray flow pattern is fabricated into either or both of insert's top and bottom outer surfaces. These circuits take the form of flow passages that are recessed from the top or bottom surfaces and molded into the member so as to yield a predetermined flow path for the fluid flowing through such inserts. Alternatively, two fluidic inserts having circuits in their top surfaces can be oriented so that the circuits face each other and the inserts welded together along their adjoining faces so as to form a taller than normal fluidic circuit for large flow rate and other specialty fluid flow applications.

There are many different and well known designs of fluidic circuits that are suitable for use with the fluidic inserts of the present invention. Many of these have some common features, including: at least one power nozzle configured to accelerate the movement of the liquid that flows under pressure through the insert, an interaction chamber through which the liquid flows and in which the fluid flow phenomena is initiated that will eventually lead to the flow from the insert being of an oscillating nature, and an outlet from which the liquid exits the insert 86. In passing, it can be noted that a common method for describing such fluidic circuits is to present the top view of such an insert so as to reveal the assumed, two-dimensional internal geometry of the insert's fluidic circuit.

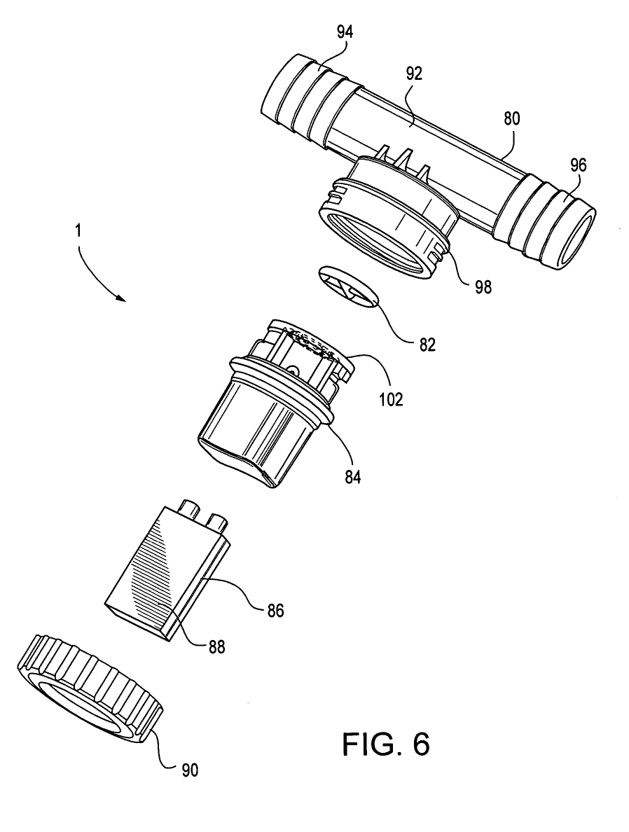

FIG. 6 shows the same nozzle assembly shown in FIG. 5, but with dashed lines so that the internal configurations of the various pieces of the assembly can be seen.

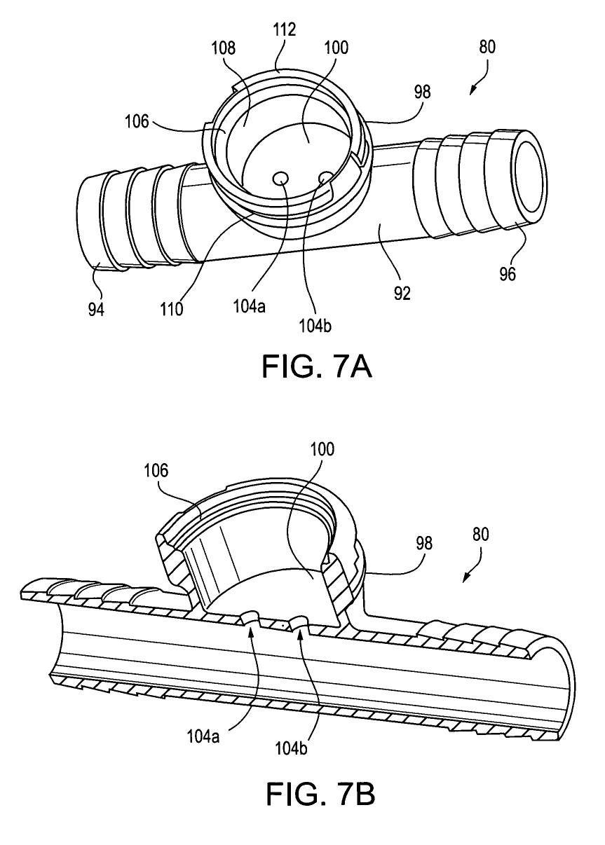

The piping tee 80 of this embodiment consists of a pipe 92 which forms the top portion of the tee and has ends 94, 96 which are configured for mating with the piping which brings the fluid supply to the nozzle assembly. The base 98 of the tee has a flat, interior surface 100 to allow a tight seal to be made with the bottom or upstream surface 102 of the housing member 84 which sits flush on the base's bottom surface 100. See also FIGS. 7A and 7B. This base bottom surface 100 has two connector orifices or holes 104a, 104b which allow the fluid which passes through the tee's top portion to begin its journey through the nozzle assembly. The surface area proximate these orifices is configured in such a way so as to aid in providing a minimal leakage union with upstream end of the housing 84 which abuts to this surface. The inner wall 106 of the base has a protuberance 108 which is configured to mate with a slot on the housing member's outer surface so as to act as a stop to restrict the amount of angular rotation, related to the valving function of this member, that this member can experience when properly seated in the tee's base portion.

The top or downstream, outer portion of the tee's base wall has matching vertical and horizontally configured slots 110, 112 which mate with protuberances on either side of the inside surface of the retention cap 90 so as to form a means for locking the retention cap into the piping tee by the rotation of the retention cap 90 relative to the tee 80 when the protuberances are properly located in their respective slots 110, 112.

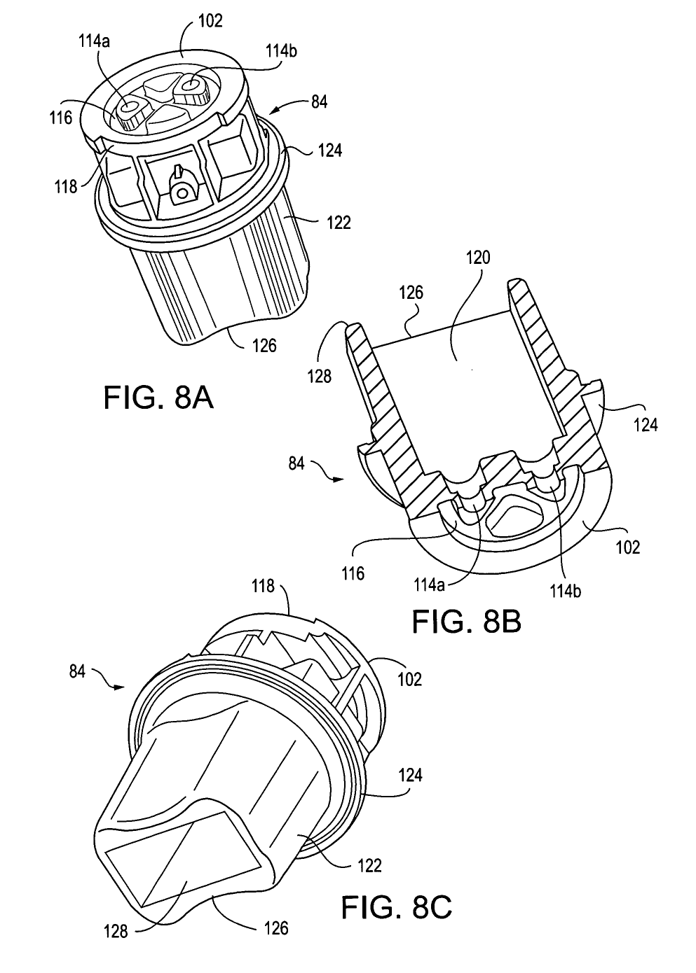

The bottom or upstream surface 102 of the housing member 84 is shown in FIG. 8A. As previously noted, this surface 102 is generally flat so that it can mate well with the bottom 100 of the tee's base. Two housing orifices or holes 114a, 114b in this surface allow the fluid to continue to pass thru this member. To prevent leakage from these holes or the holes 104a, 104b in the tee, a sealing gasket 82 is used. This bottom surface also has a grove 116 which is configured in such a way so as to form a seat which serves to hold the gasket 82 in place. See FIG. 8B.

The bottom outer surface 102 of this housing member also has a slot 118 which serves, in conjunction with the tee's inner protuberance 108, to restrict the amount of angular rotation associated with valving that this member may experience when seated in the tee's base. When the holes 114a, 114b and 104a, 104b are aligned, fluid may flow freely through the nozzle. However, when this member 84 is rotated by approximately ninety degree, these holes are seen to be totally misaligned so that no flow can occur through the nozzle.

The interior portions of this housing 84 is configured so as to form a cavity 120 which can accept and hold the selected fluidic insert 86 in place. Meanwhile, its top or downstream, outer portion 122 is configured so that it can serve as a handle which can easily be gripped and angularly rotated so as to open or close the flow through the nozzle. See FIG. 8C.

Between this housing's top and bottom portions there exists a rib 124 that extends perpendicular from the housing's outer surface. This rib 124 is used to pull this housing 84 down onto the tee 80 when the overlapping retention cap 90 is locked onto the tee 80. An opening 126 in the top surface 128 of this housing is configured so as to allow the fluidic insert 86 to be press-fit inserted into the housing 84, with the fluidic insert 86 oriented so that the its fluidic circuit outlet sprays fluid away from this housing's top or downstream surface 128.

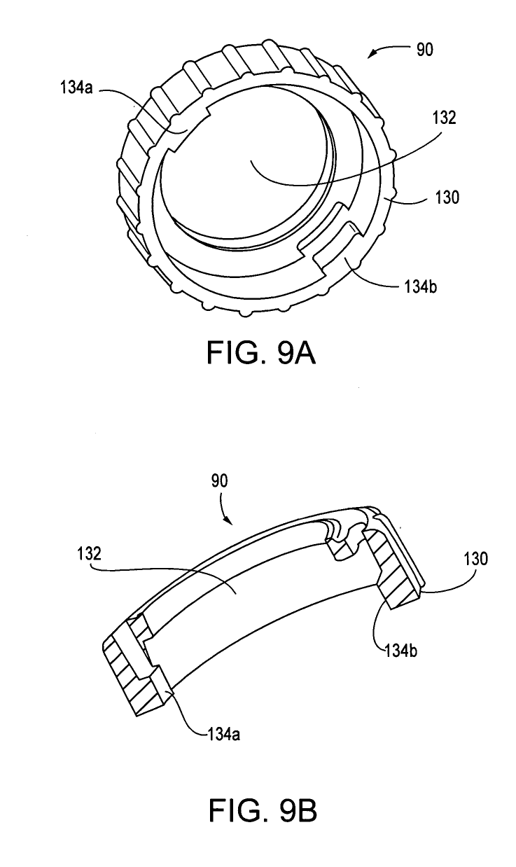

FIGS. 9A-9B show the bottom or upstream surface 130 of the retention cap 90. This surface is seen to have a central opening 132 and protuberances 134a, 134b which can be mated with the tee's outer slots 110, 112 so as to lock these two pieces together.

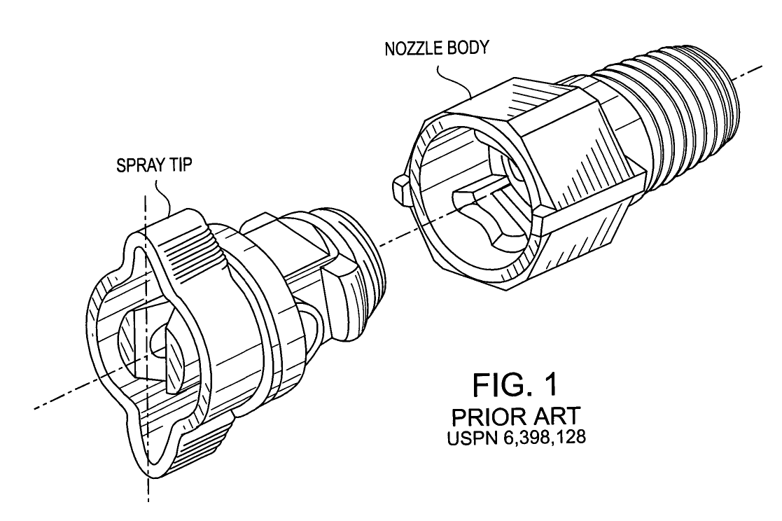

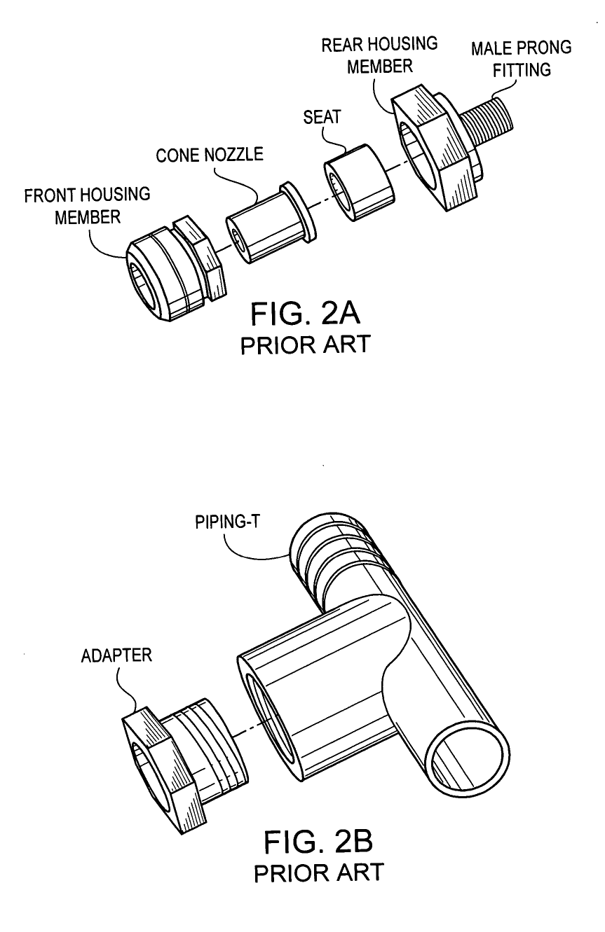

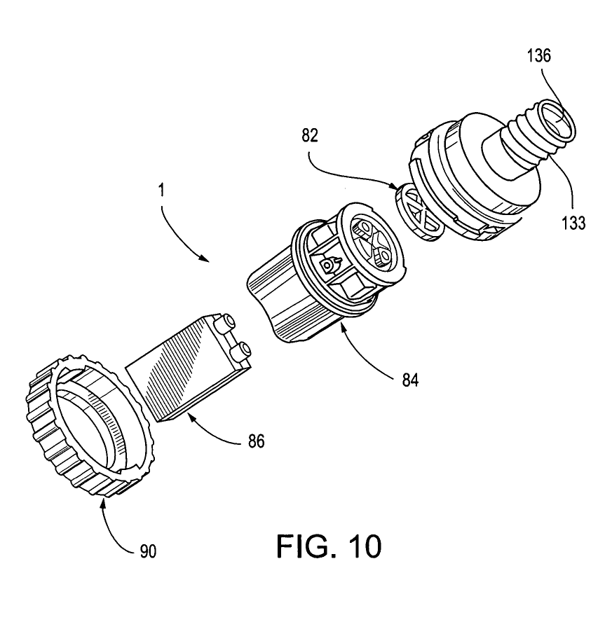

As previously mentioned, many embodiments of the present invention, which will not be mentioned herein, will be immediately obvious to one knowledgeable in those arts which are applicable to the present invention. For example, the embodiments shown in FIGS. 1-9 are shown as being applicable to those situations in which it is desired to use a tee to connect into the piping system which is to supply water to these nozzles. If such a piping system already has a connection that can received a threaded member, then it is obvious to reform the previously shown tee or connector elements 10 or 80 so that they consist of similar base portions 30 or 98 whose bottom or upstream portions are reconfigured so that they form an inlet 136 whose outer surface has external threads 138 which are used to connect this nozzle assembly to a fluid supply source. See FIG. 10.

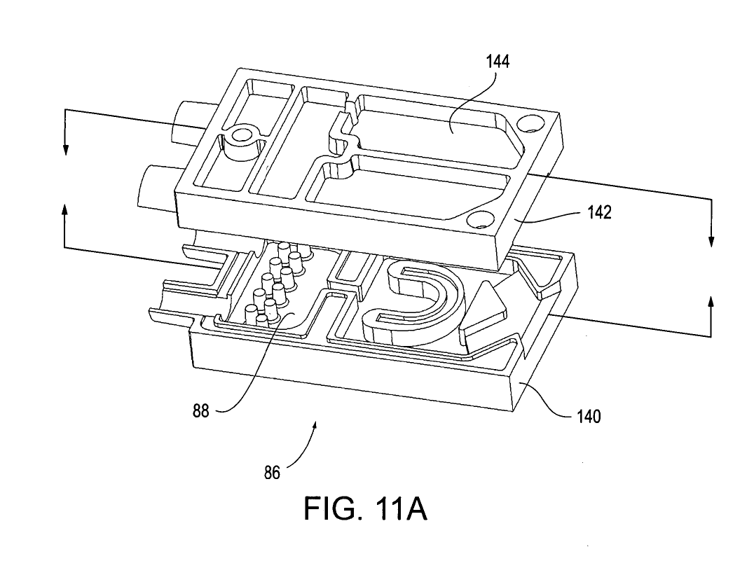

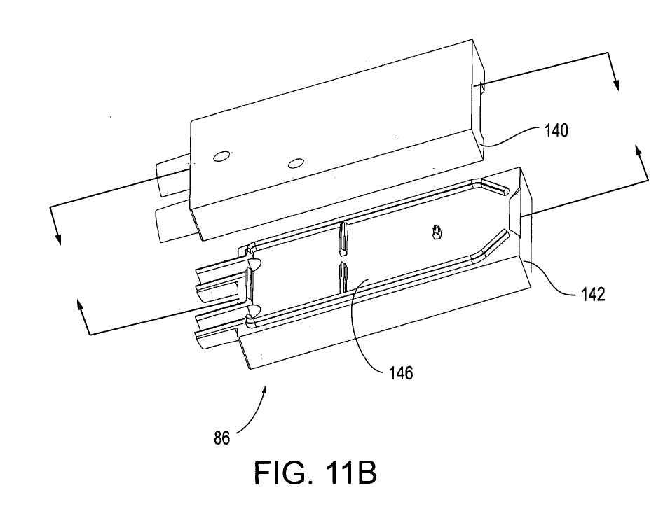

Examples of the fluidic inserts 86 which can be used in the assembly of the present invention are shown in FIGS. 11-14. FIGS. 11A show top perspective, exploded view of a first preferred fluidic insert embodiment in the form of an insert that is comprised of a body 140 and a lid 142 member and in which a fluidic circuit is molded only in the body 140 member. In a preferred embodiment, this insert is scaled to operate at water flowrates of about 0.3-0.5 gallons per minute (GPM) so as to yield water droplets with an average size of 0.8-1.5 mm. Various cutouts 144 are made in the insert for injection molding reasons, and a raised seal 146 aids in welding the body and lid members together. See FIG. 11B which shows these members having been rotated 180 degrees about their longitudinal centerlines and the body member 140 being laced above the lid member 142.

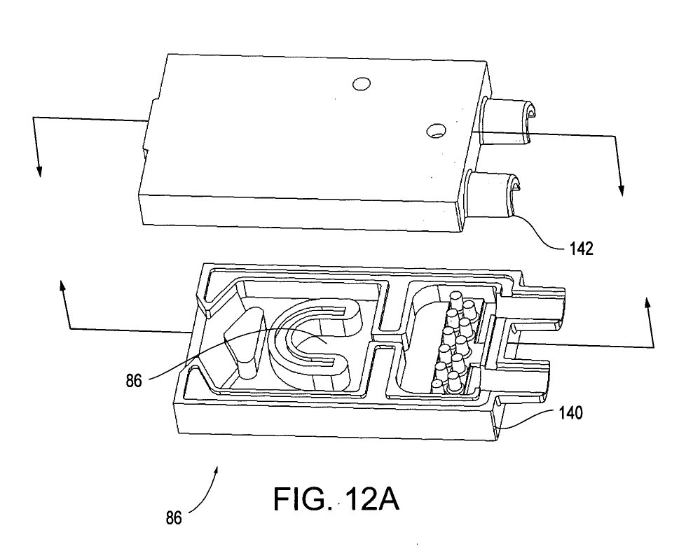

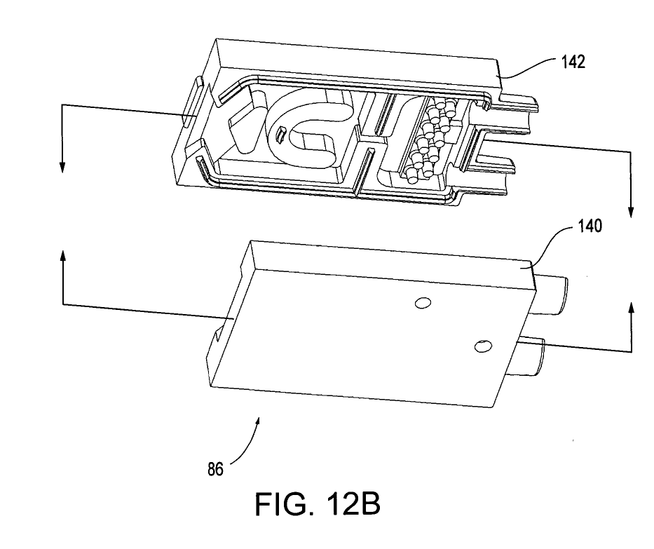

FIGS. 12A-12B show similar views of a second preferred fluidic insert embodiment in which a fluidic circuit is molded into both the body 140 and lid 142 members. In a preferred embodiment, this insert is scaled to operate at water flowrates of about 0.75-1.25 GPM so as to yield water droplets with an average size of 1.0-2.0 mm.

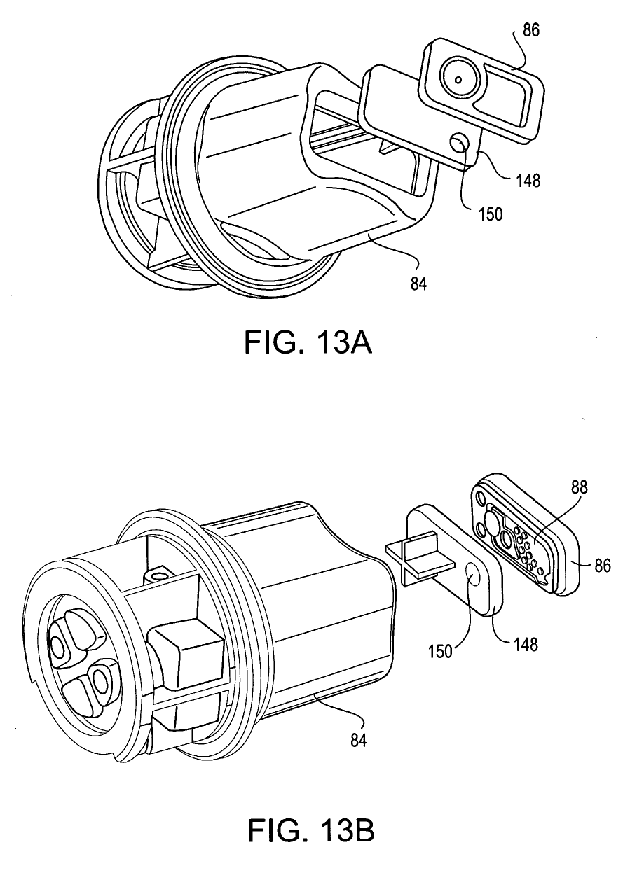

FIGS. 13A-13B show a quite different preferred embodiment for the present invention. In this embodiment, this nozzle assembly operates at a very low flow rate of about 0.01-0.03 GPM so as to yield a mist spray which has average droplet sizes of about 0.05-0.20 mm. This is achieved by adding a significant swirl and lateral flow component to the fluid flowing from such an assembly. A standard housing 84, as previously described, has inserted into its downstream end an orifice reduction member 148 which has an orifice 150 that is considerably smaller in area than that of the housing's downstream end. In front of this member is a fluidic insert 86 whose fluidic circuit 88 lies in a plane which is perpendicular to that of the housing's longitudinal centerline. The fluidic circuit's relative orientation in this manner is seen to cause the resulting fluid spray to have its significant swirl and lateral flow components.

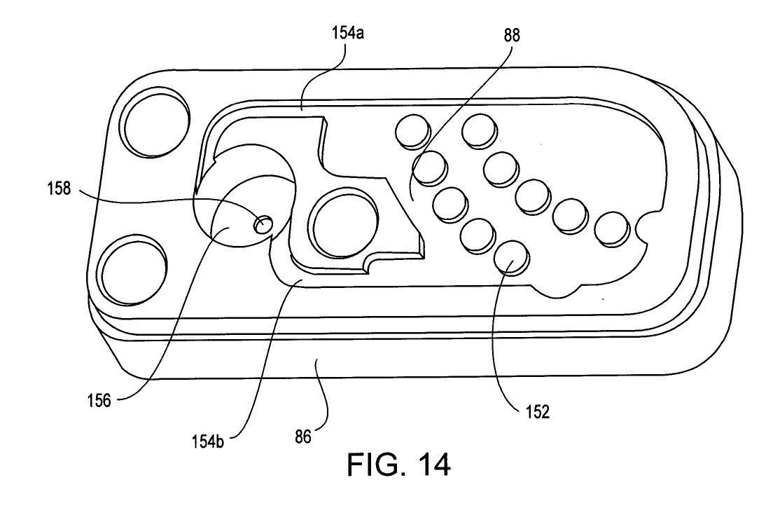

FIG. 14 shows this fluidic circuit in more detail. Flow impacts on this insert in this circuit's upper, right-hand corner and spreads laterally past its filter posts 152 and into its top 154a and bottom 154b power nozzles and into its interaction chamber 156 which produces the flow's swirling component before the flow exits the circuit through its outlet 158.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention as will be eventually in the claims of this application's to-be-filed regular, utility application.

We claim:

1. A nozzle assembly for connecting to the outlet of a fluid flow source and providing a specified fluid flow spray, said assembly comprising:
a connector having a flow passage through said connector, said passage having upstream and downstream ends, wherein said upstream end is configured so as to mate with said fluid flow source outlet, wherein said connector passage at a point between said ends having a connector orifice and a surrounding surface,
a nozzle configured so as to generate said fluid flow spray,
a housing having upstream and downstream ends and a fluid flow passage between said ends, wherein the portion of said passage proximate said downstream end being configured so as to house said nozzle, wherein the upstream end of said housing passage having a housing orifice, wherein said housing upstream end configured so as to mate with said connector surrounding surface so as to allow fluid to flow from said connector orifice into said housing orifice, said housing exterior surface at a point between said housing ends having an outwardly projecting rib, and
a retention cap having upstream and downstream ends and an opening extending between said ends, said opening configured to allow the downstream end of said housing to project through said opening, said cap upstream end configured to mate with said housing rib and said connector downstream end so as to hold said housing and connector in a proximal relationship so as to aid in preventing fluid flow leakage at the junction of said housing upstream end and said connector downstream end.

2. A nozzle assembly as recited in claim 1, wherein said housing having a rear portion that includes said upstream end and a front portion that includes said downstream end, said portions being configured so as to be connectable at their adjoining faces, said portions being separable at said adjoining faces so as to allow for the insertion of said nozzle into said housing.

3. A nozzle assembly as recited in claim 1, wherein said nozzle is a fluidic insert.

4. A nozzle assembly as recited in claim 2, wherein said nozzle is a fluidic insert.

5. A nozzle assembly as recited in claim 3, wherein the portion of said housing fluid flow passage proximate said downstream end being further configured to allow for the insertion of said fluidic insert through said downstream end of said housing passage.

6. A nozzle assembly as recited in claim 1, wherein the exterior of said housing proximate said upstream end being configured so as to be rotatably mounted in the downstream end of said connector fluid flow passage, with said housing being rotatable being a first position in which said orifices are not aligned and no fluid flows through said passages and a second position in which said orifices are aligned and fluid flows through said passages.

7. A nozzle assembly as recited in claim 6, wherein the downstream end of said housing exterior surface configured to act as a handle and aid in the rotation of said housing within said connector.

8. A nozzle assembly as recited in claim 6, wherein said nozzle is a fluidic insert.

9. A nozzle assembly as recited in claim 7, wherein said nozzle is a fluidic insert.

10. A nozzle assembly as recited in claim 8, wherein the portion of said housing fluid flow passage proximate said downstream end being further configured to allow for the insertion of said fluidic insert through said downstream end of said housing passage.

11. A nozzle assembly as recited in claim 9, wherein the portion of said housing fluid flow passage proximate said downstream end being further configured to allow for the insertion of said fluidic insert through said downstream end of said housing passage.

12. A nozzle assembly as recited in claim 6, wherein said housing having a rear portion that includes said upstream end and a front portion that includes said downstream end, said portions being configured so as to be connectable at their adjoining faces, said portions being separable at said adjoining faces so as to allow for the insertion of said nozzle into said housing.

13. A nozzle assembly as recited in claim 8, wherein said fluidic insert having a fluidic circuit configured to yield a fluid spray having droplets with an average size in the range of 0.8-1.5 mm when fluid flows through said nozzle at a flowrate in the range of 0.3-0.5 gallons per minute.

14. A nozzle assembly as recited in claim 10, wherein said fluidic insert having a fluidic circuit configured to yield a fluid spray having droplets with an average size in the range of 0.8-1.5 mm when fluid flows through said nozzle at a flowrate in the range of 0.3-0.5 gallons per minute.

15. A nozzle assembly as recited in claim 8, wherein said fluidic insert having a fluidic circuit configured to yield a fluid spray having droplets with an average size in the range of 1.0-2.0 mm when fluid flows through said nozzle at a flowrate in the range of 0.75-1.25 gallons per minute.

16. A nozzle assembly as recited in claim 10, wherein said fluidic insert having a fluidic circuit configured to yield a fluid spray having droplets with an average size in the range of 1.0-2.0 mm when fluid flows through said nozzle at a flowrate in the range of 0.75-1.25 gallons per minute.

17. A nozzle assembly as recited in claim 8, wherein said fluidic insert having a fluidic circuit configured to yield a fluid spray having droplets with an average size in the range of 0.05-0.20 mm when fluid flows through said nozzle at a flowrate in the range of 0.01-0.03 gallons per minute.

18. A nozzle assembly as recited in claim 10, wherein said fluidic insert having a fluidic circuit configured to yield a fluid spray having droplets with an average size in the range of 0.05-0.20 mm when fluid flows through said nozzle at a flowrate in the range of 0.01-0.03 gallons per minute.
